(19) United States
(12) Patent Application Publication
(10) Pub. No.: US 2016/0352877 A1
(43) Pub. Date: Dec. 1, 2016

(54) ENCLOSURE FOR ELECTRONIC DEVICE

(71) Applicant: HON HAI PRECISION INDUSTRY CO., LTD., New Taipei (TW)

(72) Inventors: MI-CHIEN CHEN, New Taipei (TW); CHUN-JEN LIN, New Taipei (TW); SHIEN-CHENG KUO, New Taipei (TW)

(21) Appl. No.: 14/834,653

(22) Filed: Aug. 25, 2015

(30) Foreign Application Priority Data
May 29, 2015 (CN) 201510285159.7

(51) Int. Cl. H04M 1/02

(52) U.S. Cl. CPC H04M 1/0279

(57) ABSTRACT

An enclosure for a handheld electronic device includes a base defining a recess, a rectangular, hollow frame, a rectangular, hollow double-sided adhesive tape, a rectangular, hollow silicone rubber layer and a transparent plate. The recess receives therein a main body and a display panel of the electronic device. The frame, the double-sided adhesive tape and the silicone rubber layer are sequentially received in the recess along a direction from an inside toward an opening of the recess of the enclosure and surround the display panel. The transparent plate is secured to fronts of the silicone rubber layer and the display panel and adhered by the silicon rubber layer to cover the opening of the recess.

### CROSS-REFERENCE TO RELATED APPLICATIONS

This application claims priority to Chinese Patent Application No. 201510285159.7 filed on May 29, 2015, the contents of which are incorporated by reference herein.

### FIELD

The subject matter herein generally relates to an enclosure for an electronic device, and particularly to an enclosure for a handheld electronic device which has a transparent cover.

### BACKGROUND

Handheld electronic devices, such as tablet computers or mobile phones such as smartphones, generally have transparent covers to facilitate touch controls made to the handheld electronic devices. The transparent covers are made of glass plates which are secured to bases of enclosures of the handheld electronic devices through double-sided adhesive tapes. Due to the double-sided adhesive tapes being very sticky, it is difficult to remove the covers from the bases to perform maintenances or repairs to the handheld electronic devices when necessary.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an electronic device having an enclosure in accordance with the present disclosure.

FIG. 2 is an exploded, isometric view of the electronic device of FIG. 1.

FIG. 3 is an exploded, isometric view of a front cover assembly of the enclosure of the electronic device FIG. 2.

FIG. 4 is a cross-sectional view of the electronic device taken along line IV-IV of FIG. 1.

FIG. 5 is an enlarged view of a circled portion V of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

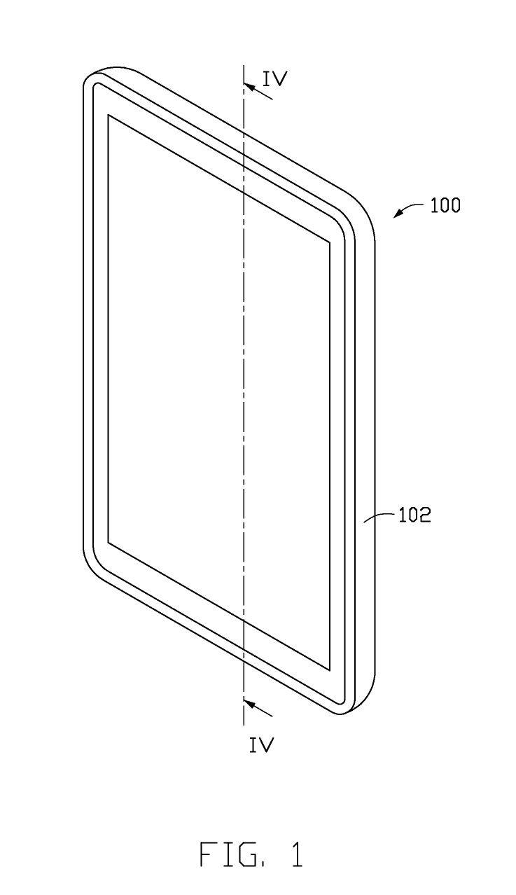

Referring to FIG. 1, an electronic device 100 having an enclosure 102 in accordance with the present disclosure is shown. The electronic device 100 in the illustrated embodiment is a handheld electronic device which can be a tablet computer or a mobile phone such as a smartphone.

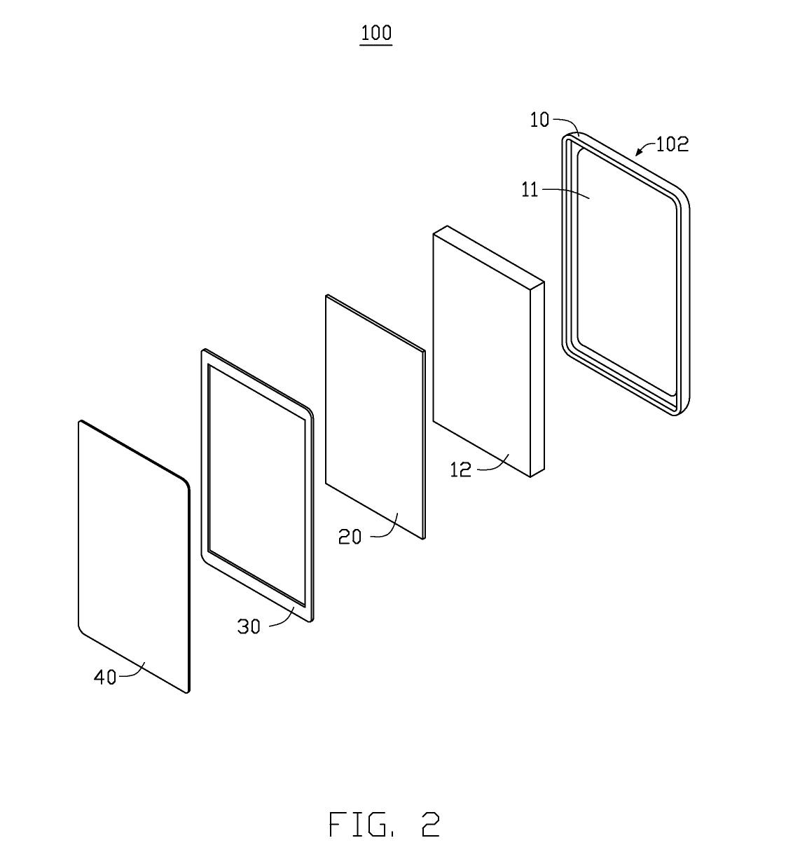

As illustrated in FIG. 2, the electronic device 100 includes a main body 12 which includes a plurality of electronic components (not shown) such as a central processing unit, a battery, memories and a circuit board, and a display panel 20 having a touch control function. The enclosure 102 includes a base 10 which has a substantially U-shaped cross section thereby defining an accommodating recess 11, a substantially rectangular, hollow frame 30 and a front cover assembly 40.

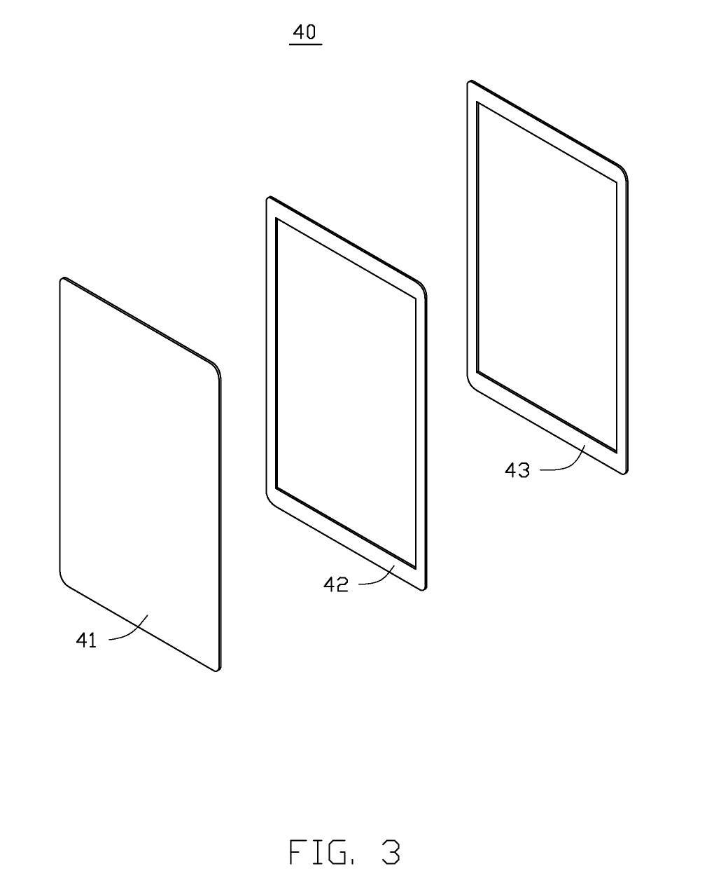

As shown in FIG. 3, the front cover assembly 40 includes a transparent protective plate 41, a silicone rubber layer 42, and a double-sided adhesive tape 43. Each of transparent protective plate 41, the silicone rubber layer 42 and the double-sided adhesive tape 43 has a substantially rectangular shape. Furthermore, each of the silicon rubber layer 42 and the double-sided adhesive tape 43 is hollow and defines a substantially rectangular hole (not labeled) therethrough. The hollow double-sided adhesive tape 43 has a size and shape substantially the same as a size and shape of the hollow silicone rubber layer 42. The transparent protective plate 41 can be made of glass. By a touch operation to the transparent protective plate 41, the operation can be transmitted to the touch operation controllable display panel 20 to control operations of the electronic device 100.

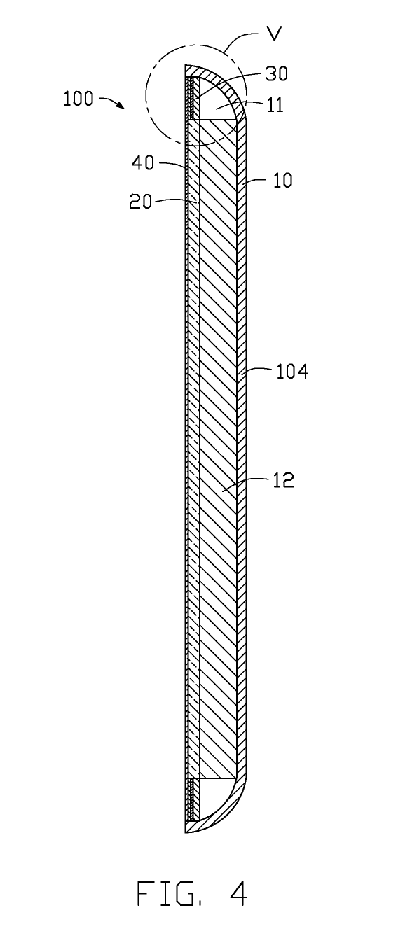

Referring to FIG. 4, in assembly, the main body 12, the display panel 20, the frame 30 and the front cover assembly 40 are received in the recess 11 of the base 10. The main body 12 abuts a rear plate 104 of the base 10. The display panel 20 is mounted on a front of the main body 12. The frame 30 is positioned near an edge of the base 10 and fittingly surrounds the display panel 20. The frame 30 can be securely coupled to the base 10 by screws (not shown) which extend through the frame 30 and engage in the base 10. Alternatively, the frame 30 can be integrally formed with the base 10 as a monolithic piece. The front cover assembly 40 is mounted in a front of the base 10 to cover the recess 11. The base 10 preferably includes various ridges or indentations to receive the various components and maintain them in the desired position.

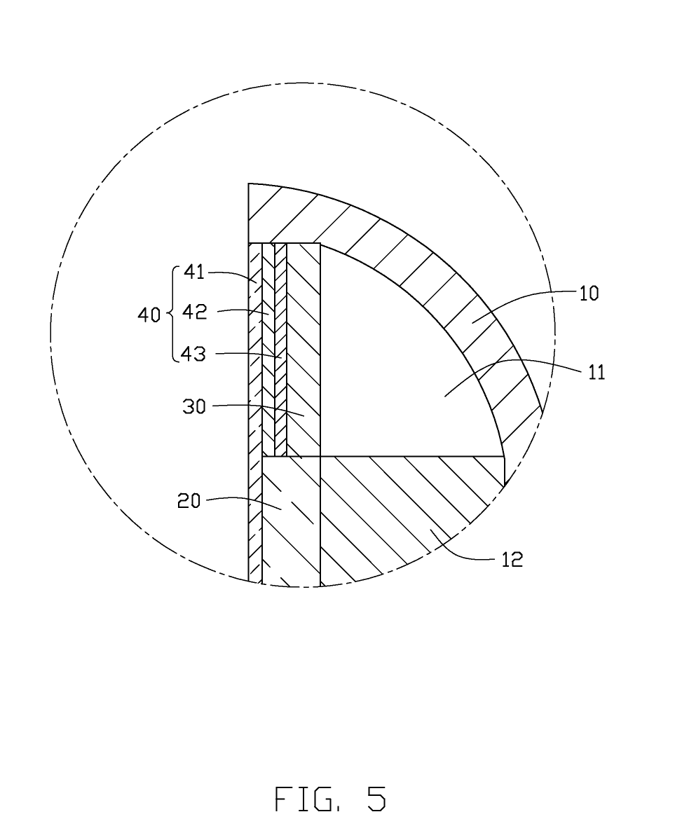

Referring to FIG. 5, the double-sided adhesive tape 43 of the front cover assembly 40 is mounted near the edge of the base 10, surrounds the display panel 20 and on a front of the frame 30. A rear side of the double-sided adhesive tape 43 is adhered to the front of the frame 30. The silicone rubber layer 42 is mounted near the edge of the base 10, surrounds the display panel 20 and is mounted on a front of the double-sided adhesive tape 43. A rear side of the silicone rubber layer 42 is adhered to the front of the double-sided adhesive tape 43. In practice, the silicone rubber layer 42 is applied to an edge of a rear face of the transparent protective plate 41 by printing beforehand. When the transparent protective plate 41 is mounted to the base 10, the silicone rubber layer 42 is adhered to the double-sided adhesive tape 43. A thickness of the silicone rubber layer 42 can be adjusted according to the actual requirement. The transparent protective plate 41 is mounted on front of the display panel 20 and the silicone rubber layer 42 to totally cover a front opening of the recess 11.

When it is necessary to remove the transparent protective plate 41 to process maintenance or repair to the electronic device 100, the transparent protective plate 41 is forcedly separated from the silicone rubber layer 42. The silicone rubber layer 42 has such a stickiness that it can adhere the transparent protective plate 41 thereto under a normal use of the electronic device 10, yet readily be removed/peeled away; this differs from the adhesion of the tape, which in this environment would be destructive to the tape (in that it would tear or separate). The transparent protective plate 42 can be separated from the silicone rubber layer 42 when a sufficiently large non-destructive removal force is applied thereto, without the worry that a part of the silicone rubber layer 42 will remain on and contaminate the rear face of the transparent protective plate 41 by the forced separation. After the maintenance or repair of the electronic device 100, the transparent protective plate 41 can be put back to its original position again to be reliably adhered to the silicone rubber layer 42.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An enclosure for an electronic device, comprising:
a base defining a recess;
a hollow frame received in the recess and secured to the base;
a hollow double-sided adhesive tape received in the recess and secured to the hollow frame;
a hollow silicone rubber layer received in the recess and secured to the hollow double-sided adhesive tape; and
a transparent protective plate secured to the hollow silicon rubber layer to cover an opening of the recess.

2. The enclosure of claim 1, wherein the hollow double-sided adhesive tape has a size and shape substantially the same as a size and shape of the hollow silicone rubber layer.

3. The enclosure of claim 1, wherein the transparent protective plate is made of glass.

4. The enclosure of claim 3, wherein the transparent protective plate is subjected to touch control operation configured for controlling operation of the electronic device.

5. The enclosure of claim 1, wherein the transparent protective plate is subjected to touch control operation configured for controlling operation of the electronic device.

6. A handheld electronic device comprising:
a base defining a recess;
a main body received in the recess;
a touch operation controllable display panel received in the recess and in front of the main body;
a double-sided adhesive tape received in the recess and coupled to the base;
a silicone rubber layer received in the recess and secured to the double-sided adhesive tape; and
a plate secured to the silicone rubber layer to cover an opening of the recess and the display panel;
wherein a touch control operation to the plate is transmissible to the display panel to control operation of the handheld electronic device.

7. The handheld electronic device of claim 6, wherein the plate is transparent.

8. The handheld electronic device of claim 7, wherein the plate is made of glass.

9. The handheld electronic device of claim 8, wherein the plate is substantially rectangular.

10. The handheld electronic device of claim 9, further comprising a frame received in the recess and secured to the base and fittingly surrounding the display panel, the double-sided adhesive tape being secured to the frame.

11. The handheld electronic device of claim 6, further comprising a frame received in the recess, secured to the base and fittingly surrounding the display panel, the double-sided adhesive tape being secured to the frame.

12. The handheld electronic device of claim 11, wherein the frame is integrally formed with the base as a monolithic piece.

13. An enclosure for an electronic device, comprising:
a base defining a recess;
a hollow frame received in the recess and secured to the base;
a hollow double-sided adhesive tape received in the recess and fixedly secured to the hollow frame by adhesion from the tape;
a hollow silicone rubber layer received in the recess and fixedly secured to the hollow double-sided adhesive tape by adhesion from the tape; and
a transparent protective plate releasably secured to the hollow silicon rubber layer by adhesion from the silicon rubber layer to cover an opening of the recess;
wherein the adhesion by the tape defines a connection which cannot be separated absent application of destructive force, and the adhesion by the silicon rubber layer defines a connection that can be separated absent application of destructive force.
